(19) United States
(12) Patent Application Publication
(10) Pub. No.: US 2015/0208000 A1
(43) Pub. Date: Jul. 23, 2015

(54) PERSONALIZED MEDIA REMIX

(71) Applicant: Nokia Corporation, Espoo (FI)

(72) Inventor: Juha Petteri Ojanperä, Nokia (FI)

(73) Assignee: Nokia Corporation, Espoo (FI)

(21) Appl. No.: 14/421,871

(22) PCT Filed: Oct. 22, 2012
(86) PCT No.: PCT/FI2012/051007

§ 371 Date: Feb. 16, 2015

(51) Int. Cl. H04N 5/265; H04N 5/93; H04N 21/8549; G11B 27/036

(52) U.S. Cl. CPC H04N 5/265; G11B 27/036; H04N 5/9305; H04N 21/8549

(57) ABSTRACT

An embodiment of the invention relates to a method comprising receiving media content from at least one recording device, wherein at least one media content received from said at least one recording device is complemented with personating data and creating remixed media content of the media content being received with said at least one personating data. In addition an embodiment of the invention relates to a method comprising capturing media content by a recording device; monitoring the capture of the media content by logging personating data to the recording device and transmitting at least part of the captured media content to a server, which at least part of the captured media is complemented with the personating data. Embodiments of the present invention also relates to a technical equipment for executing the methods.

### TECHNICAL FIELD

The present solution relates generally to a method and a technical equipment for creating media remix of a media being recorded by multiple recording devices.

### BACKGROUND

Multimedia capturing capabilities have become common features in portable devices. Thus, many people tend to record or capture an event, such as a music concert or a sport event, they are attending.

Media remixing is an application where multiple media recordings are combined in order to obtain a media mix that contains some segments selected from the plurality of media recordings. Video remixing, as such, is one of the basic manual video editing applications, for which various software products and services are already available. Some automatic video remixing systems depend only on the recorded content, while others are capable of utilizing environmental context data that is recorded together with the video content. The context data may be, for example, sensor data received from a compass, an accelerometer, or a gyroscope, and/or location data.

### SUMMARY

Now there has been invented an improved method and technical equipment implementing the method, by which the media remix of a multicaptured media can be personalized for a particular user. Various aspects of the invention include methods, apparatuses, a system and a computer readable medium comprising a computer program stored therein, which are characterized by what is stated in the independent claims. Various embodiments of the invention are disclosed in the dependent claims.

According to a first aspect, the method comprises receiving media content from at least one recording device, wherein at least one media content received from said at least one recording device is complemented with personating data; creating remixed media content of the media content being received with said at least one personating data.

According to a second aspect, an apparatus comprises at least one processor, memory including computer program code, the memory and the computer program code configured to, with the at least one processor, cause the apparatus to perform at least the following: receive media content from at least one recording device, wherein at least one media content received from said at least one recording device is complemented with personating data; create remixed media content of the media content being received from with said at least one personating data.

According to a third aspect, an apparatus comprises at least means for processing, memory means including computer program code, means for receiving media content from at least one recording device, wherein at least one media content from said at least one recording device is complemented with personating data; means for creating remixed media content of the media content being received with said at least one personating data.

According to a fourth aspect, a computer program product embodied on a non-transitory computer readable medium, comprising computer program code configured to, when executed on at least one processor, cause an apparatus or a system to: receive media content from at least one recording device, wherein at least one media content received from said at least one recording device is complemented with personating data; create remixed media content of the media content being received with said at least one personating data.

According to a fifth aspect, a computer program product embodied on a non-transitory computer readable medium comprising computer program code for user with a computer, the computer program code comprising code for receiving media content from at least one recording device, wherein at least one media content received from said at least one recording device is complemented with personating data; code for creating remixed media content of the media content being received with said at least one personating data.

According to an embodiment, a request from a user is received to provide a remixed media content to said user.

According to an embodiment, a mood of the user is analyzed by means of the received face image.

According to an embodiment the received media content is at least partly video content, wherein video content received from multiple recording devices is examined to find such content that comprises data corresponding to the face image.

According to an embodiment, a cluster is created for recording devices sharing a common grouping factor.

According to an embodiment, for examining the video content received from multiple recording devices to find such content that comprises data corresponding to the face image, such video content is selected from the video content received from multiple recording devices that has been recorded by recording devices belonging to a same cluster with the recording device having provided the face image.

According to an embodiment, the personating data is the personating data of the requesting user.

According to an embodiment, the personating data is data on user activities during media capture.

According to an embodiment, the personating data is data on activities of the recording device during media capture.

According to an embodiment, the personating data includes a face image of the user of the recording device.

According to an embodiment, the grouping factor is an audio, whereby the cluster is created for recording devices sharing a common audio timeline.

According to an embodiment, the grouping factor is a location, whereby the cluster is created for recording devices sharing being close to each other.

According to a sixth aspect, a method comprises capturing media content by a recording device; monitoring the capture of the media content by logging personating data to the recording device; transmitting at least part of the captured media content to a server, which at least part of the captured media is complemented with the personating data.

According to a seventh aspect, a recording apparatus comprises at least one processor, memory including computer program code, the memory and the computer program code configured to, with the at least one processor, cause the apparatus to perform at least the following: capture media content; monitor the capture of the media content by logging personating data to the recording apparatus; transmit at least part of the captured media content to a server, which at least part of the captured media is complemented with the personating data.

According to an embodiment, the personating data is data on user activities during media capture.

According to an embodiment, the personating data is data on activities of the recording device during media capture.

According to an embodiment, the personating data includes a face image of the user of the recording device.

According to an embodiment, a media remix is requested from a server with at least said personating data.

According to an eighth aspect, a system comprises at least one processor, memory including computer program code, the memory and the computer program code configured to, with the at least one processor, cause the system to perform at least the following: receive media content from at least one recording device, wherein at least one media content received from said at least one recording device is complemented with personating data; create remixed media content of the media content being received with said at least one personating data.

### DESCRIPTION OF THE DRAWINGS

In the following, various embodiments of the invention will be described in more detail with reference to the appended drawings, in which

FIG. 1 shows a system and device according to an embodiment;

FIG. 2 shows an apparatus according to an embodiment;

FIG. 3 shows a layout of an apparatus according to an embodiment;

FIG. 4 shows a server according to an embodiment;

FIG. 5 shows an embodiment of a media remixing arrangement;

FIG. 6 shows a block diagram of an embodiment for a recording device;

FIG. 7a,b show block diagrams of an alternative embodiments for a server;

FIG. 8 shows example of media highlight segments for a media in a timeline;

FIG. 9 shows a block diagram of another embodiment for the server;

FIG. 10 shows a block diagram for locating a specified user segments according to an embodiment;

FIG. 11 shows an example for FIG. 10;

FIG. 12 shows an example of user positions and capturing direction;

FIG. 13 shows a block diagram of an embodiment for creating clusters; and

FIG. 14 shows an embodiment for applying FIG. 13 analysis to media remix.

### DESCRIPTION OF EXAMPLE EMBODIMENTS

In the following, several embodiments of the invention will be described in the context of capturing media by multiple devices. In addition, the present embodiments provide a solution to create a media presentation of the recorded media, which presentation is personalized for a certain user.

As is generally known, many portable devices, such as mobile phones, cameras, and tablets, are provided with high quality cameras, which enable to capture high quality video files and still images. The recorded media content can be transmitted to a specific server configured to perform remixing of such content.

The media content to be used in media remixing services may comprise at least video content including 3D video content, still images (i.e. pictures), and audio content including multi-channel audio content. The embodiments disclosed herein are mainly described from the viewpoint of creating a video remix from video and audio content of source videos, but the embodiments are not limited to video and audio content of source videos, but they can be applied generally to any type of media content.

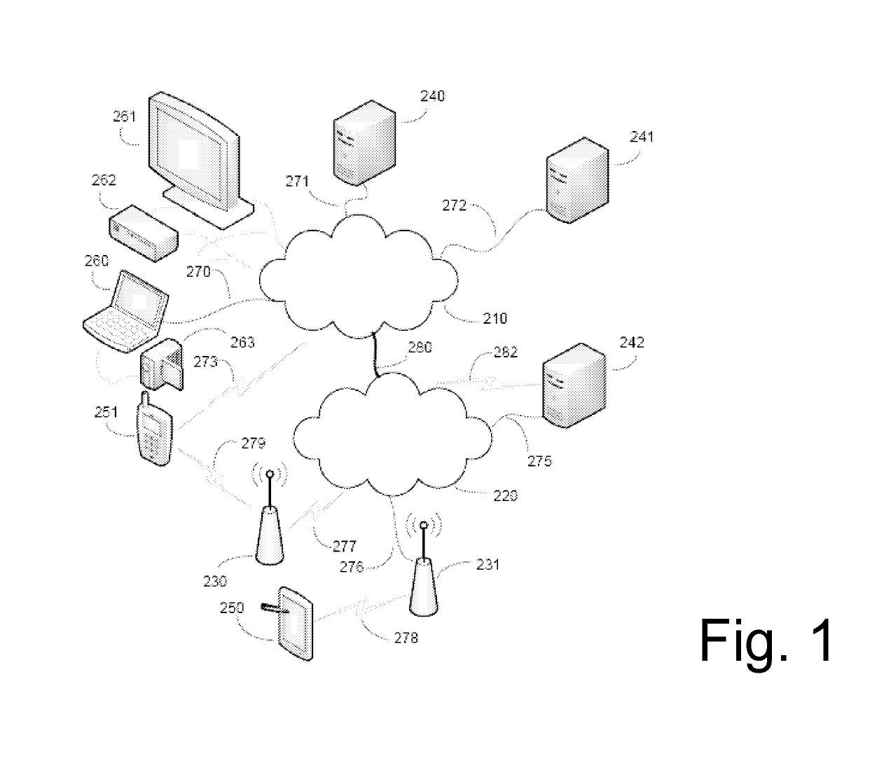

FIG. 1 shows a system and devices according to an embodiment. In FIG. 1, the different devices may be connected via a fixed network 210 such as the Internet or a local area network; or a mobile communication network 220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements such as routers and switches to handle data (not shown), and communication interfaces such as the base stations 230 and 231 in order for providing access for the different devices to the network, and the base stations 230, 231 are themselves connected to the mobile network 220 via a fixed connection 276 or a wireless connection 277.

There may be a number of servers connected to the network, and in the example of FIG. 1 are shown servers 240, 241 and 242, each connected to the mobile network 220, which servers may be arranged to operate as computing nodes (i.e. to form a cluster of computing nodes or a so-called server farm) for the automatic video remixing service. Some of the above devices, for example the computers 240, 241, 242 may be such that they are arranged to make up a connection to the Internet with the communication elements residing in the fixed network 210.

There are also a number of end-user devices such as mobile phones and smart phones 251, Internet access devices (Internet tablets) 250, personal computers 260 of various sizes and formats, televisions and other viewing devices 261, video decoders and players 262, as well as video cameras 263 and other encoders. These devices 250, 251, 260, 261, 262 and 263 can also be made of multiple parts. The various devices may be connected to the networks 210 and 220 via communication connections such as a fixed connection 270, 271, 272 and 280 to the internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection.

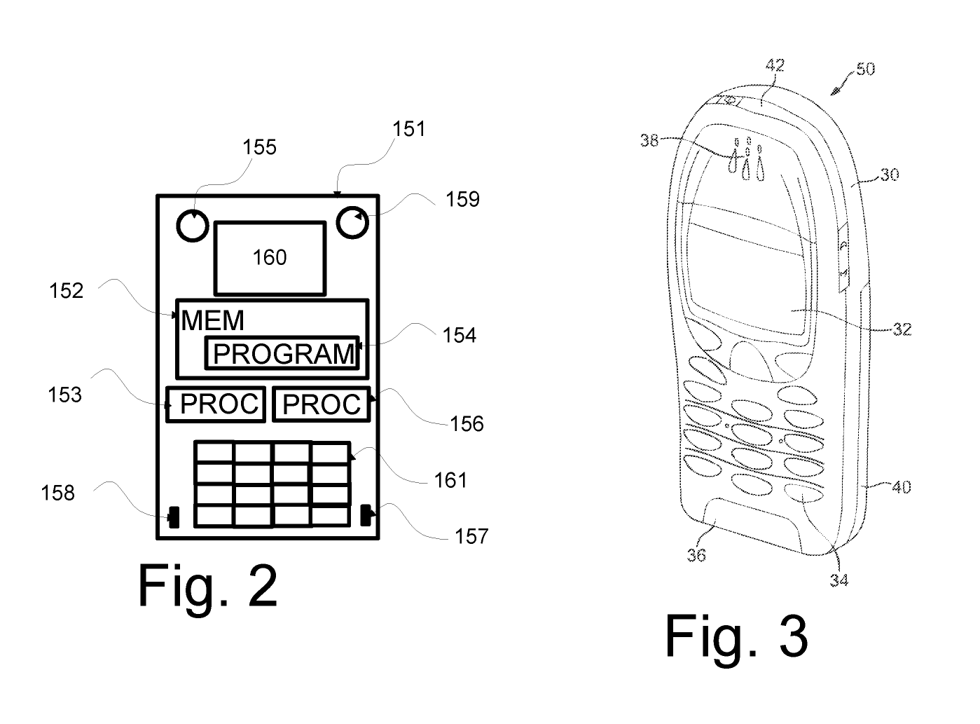

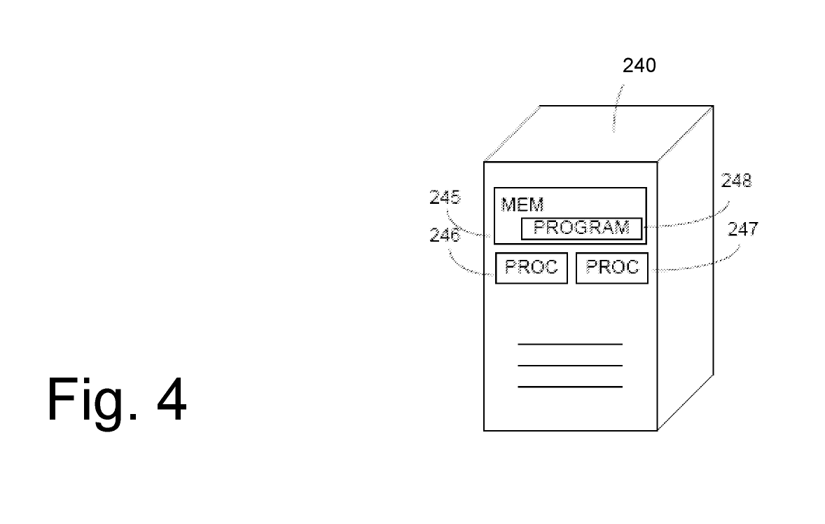

FIGS. 2-4 show devices for video remixing according to an example embodiment. As shown in FIG. 4, the server 240 contains memory 245, one or more processors 246, 247, and computer program code 248 residing in the memory 245 for implementing, for example, video remixing. The different servers 241, 242 of FIG. 1 may contain at least these elements for employing functionality relevant to each server.

Similarly, the apparatus 151 shown in FIG. 2 contains memory 152, at least one processor 153 and 156, and computer program code 154 residing in the memory 152. The apparatus may also have one or more cameras 155 and 159 for capturing image data, for example stereo video. The apparatus may also contain one, two or more microphones 157 and 158 for capturing sound. The apparatus may also contain sensor for generating sensor data relating to the apparatus' relationship to the surroundings. The apparatus may also comprise a display 160 for viewing single-view, stereoscopic (2-view) or multiview (more-than-2-view) images. The display 160 may be extended at least partly on the back cover of the apparatus. The apparatus 151 may also comprise an interface means (e.g. a user interface) which allows a user to interact with the apparatus. The user interface means may be implemented using the display 160, a keypad 161, voice control, or other structures. The apparatus may also be connected to another device e.g. by means of a communication block (not shown in FIG. 2) able to receive and/or transmit information.

FIG. 3 shows a layout of an apparatus according to an example embodiment. The electronic device 50 may for example be a mobile terminal (e.g. mobile phone, a smart phone, a camera device, a tablet device) or user equipment of a wireless communication system. However, it would be appreciated that embodiments of the invention may be implemented within any electronic device or apparatus which are capable of recording media and transmitting the recorded media to another device, e.g. a server device.

The apparatus 50 may comprise a housing 30 for incorporating and protecting the device. The apparatus 50 further may comprise a display 32 in the form of e.g. a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise an infrared port 42 for short range line of sight communication to other devices. In other embodiments the apparatus 50 may further comprise any suitable short range communication solution such as for example a Bluetooth wireless connection or a USB/firewire wired connection. The apparatus 50 may also comprise one or more camera capable of recording or detecting individual frames which are then passed to the codec or controller for processing. In some embodiments of the invention, the apparatus may receive the video image data for processing from another device prior to transmission and/or storage. In some embodiments of the invention, the apparatus 50 may receive the image either wirelessly or by a wired connection.

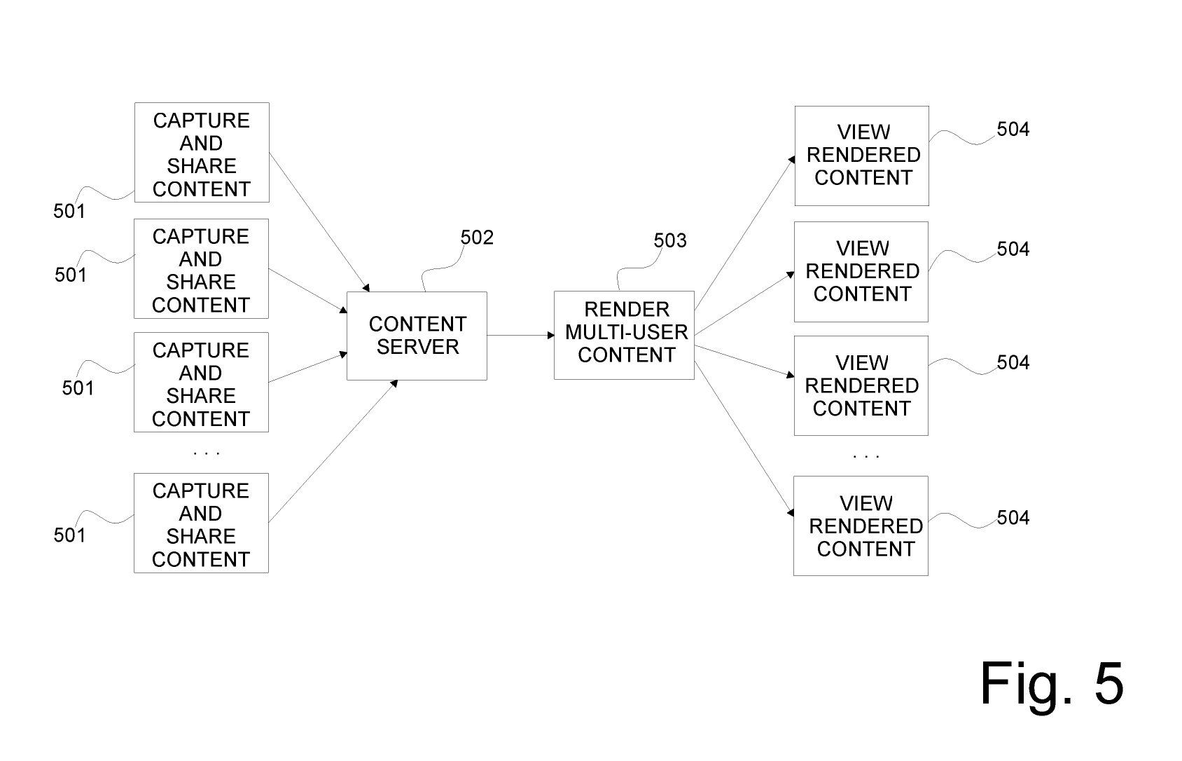

FIG. 5 illustrates an embodiment of a media remixing arrangement. The arrangement comprises more than one users (501) that are arbitrarily positioned within the space to capture content from a scene. The users have recording devices, for example mobile terminals shown in FIG. 2. The content may be audio only, audio and video, only video, still images or combination of these four. The captured content is transmitted (or alternatively stored for later consumption) to a content server (502), such as the one shown in FIG. 4, comprising rendering means (503) which provides remixed media signals to end users (504). The remixed media leverages the best media segments from multiple contributing users (501) to provide the best user experience of the multi-user rendered content. End users (504) may be users (501) who uploaded content to the server or some other users who just want to view multi-user rendered content from an event. End user may have any electronic device capable of at least receiving media data and playing the media. Examples of such a device are illustrated in FIG. 1 (250; 251; 260; 261; 262; 263)

The present embodiments propose personalizing the media remix such that each contributing user is able to obtain such a media remix where his/her captured media has preference. The personalized media remix can be created to contain such media segments which that are important for the user. These segments typically relate to such a situation where the user has experienced strong emotions. Therefore one of the purposes of the present embodiments is to propose an enabler that makes it possible to personalize media remix according to a specific user for the multi-user captured content.

An embodiment for personalizing media for a multi-user media remix comprises capturing and rendering methods. The capturing method is performed at the recording device, i.e. client device. The rendering method on the other hand may be performed at the server.

While the recording device is capturing the media content, the recording device is capable of logging and analyzing user activities that occur during capturing. The user activities can be logged and analyzed by means of sensor data. The user activities may also include logging zoom level data. The user activities may also include front camera analysis of the device for detecting and analyzing user profile. The media highlights are determined for the rendering by means of the data that has been associated with the media, e.g. as metadata. The media segments comprising media highlight(s) can be determined at the recording device or at the server. The media highlights are then rendered to multi-user media remix at the server. When a user requests personalized media remix, the media preference is selected based on user identification. Therefore, a requesting user will receive such a media remix that has been created based on his/her own preferences.

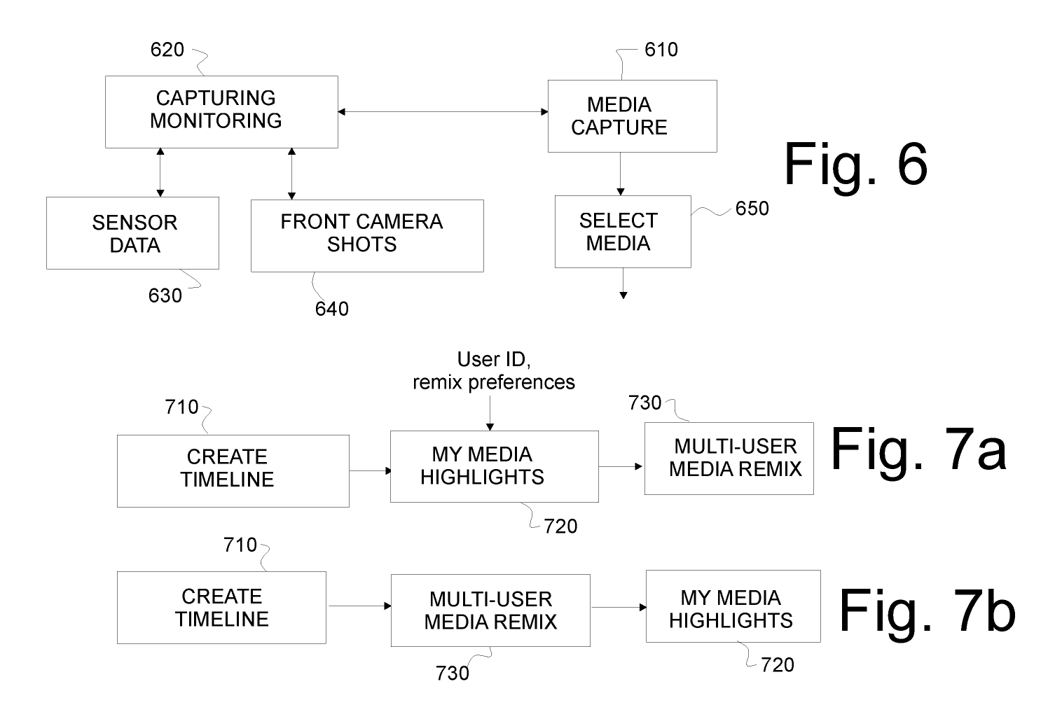

FIG. 6 shows a high level block diagram of an embodiment for the recording device. During media capture (610), the activities of the recording device and the user are monitored (620). The monitoring and data may be stored for later rendering and personalization purposes. The device activities can be monitored by storing sensor data (630) during capturing such as gyroscope/accelerometer and compass data. For carrying this out, the electronic device is capable of logging sensor entries at certain rate that corresponds to a time instance within the capturing activity. For example, compass data may be logged at 10 Hz rate, whereby 10 compass sensor entries are obtained per second that describe the user activities during capturing.

Also other activities relating to recording may be stored, such as orientation of the device, time instances when user is zooming along with the zooming level data. The recording device may be capable of logging the zooming time instance and related data in the following format

time_instant, zduration, zlevel

where time_instant is the time instant of the start of the zooming measured from the start of the capturing, zduration is the time duration user is capturing at the specified zoom level, and zlevel is then the actual zoom level.

In addition, the user's moods may be analyzed (540) and in case something relevant is detected in user's mood (such as smiling, laughing, crying, cheering etc.) those time instants are also stored for later use. The mood analysis can be carried out by analyzing image data captured by a front camera of the recording device.

The front camera analysis for monitoring and detecting user's mood may be carried out according to following steps
1 Take image shot using front camera or alternatively extract image from front camera video
2 Is face included?
3 Is it user's face?
4 Detect mood
5 Known mood detected, log time instant and mood

To determine whether the front camera image is user's face (step 3), the user has had to provide a reference image of user's face to the recording device. For detecting the mood any known face recognition methods can be used.

The front camera analysis may log data in the following format

time_instant, mduration, mood

where time_instant is the time instant of the start of the analyzed mood, mduration is the time duration of the mood, and mood is the actual mood that was analyzed.

The number of mood to be detected may depend on implementation but e.g. smiling and laughing may indicate strong emotions within that particular time segment during capturing. In addition some other sensor modalities may be used for the detection. For example, the captured audio scene is analyzed to get better confirmation that user is e.g. laughing. In such a case, the audio signal can be classified such that if sound of laughter is detected and also front camera analysis confirms this, then such data entry is logged.

It is also possible that the front camera image is recorded to a low resolution video and associated with the main media recording. The actual analysis of the mood may then be determined at the server side. This approach will result in improved battery lifetime and enables more complex processing as at the server side processing capabilities may be more advanced compared to that of a mobile device side.

At some point after the media capture has ended the user selects media to be uploaded to the content server side (650).

FIG. 7a illustrates a high level block diagram of an embodiment for the server performing at least the rendering functions. The server may also carry out some other functions, which are described later.

At first, a common timeline is created (710) for the participating media. The participating media includes media content being received from plurality of recording devices, wherein the media content relates to a shared experience, e.g. a concert, a sports event, a race, a party etc. Next, media highlights in the media for a particular user are determined (720). This means that any user who has provided media highlights together with the media content, will have his/her own media highlights at the server. The user may be determined by a user identification. For example, when a user is requesting a media remix from the content server, the media preferences may also be signaled by the user. The media preferences may be all the media the user has contributed to a particular event or only a subset of that. The media highlights for the particular user are then determined according to following steps:
1. For each media in the media preference set the logging data and other associated metadata are analyzed and the time segments that seem to include important media highlights are selected. At least the following time segments are extracted for further highlight processing:
   Detected mood segments (a)
   Zooming segments (b)
   My compass OOI (Orientation-Of-Interest) segments (c)
   My compass non-OOI segments (d)
where the orientation-of-interest (OOI) can be determined from the compass data and it describes the OOI angles (that is, dominant interest points in the compass plane) for the captured media. The non-OOI segments are the opposite of the previous, that is, non-OOI segment describes the interest point in the compass plane that is not dominant in the overall capturing activity but still represents a segment of reasonable duration (e.g. 2-5s at minimum). The non-OOI is an indication that something has activated the user to capture from a certain (deviating) direction which typically indicates important aspect for the user.
There may be overlapping time segments which may then be handled such that certain segment events have higher priority than others. For example, gyroscope/accelerometer may override compass data in case the device is tilted down or up in which case those time segments should not be used (for example, user may be capturing his/her foot for a while which most probably is not interesting event in the users capturing activity).

Finally, the media remix is generated (730). Such a media remix combines the media highlights for at least one particular user and the general multi-user media remix.

As an alternative embodiment, shown in FIG. 7b, the general multi-user media remix may be generated first and then the segments (or media views) from the remix are replaced with the media highlight segments (or media views) to personalize the media remix. The rendered media can then be provided to end user consumption.

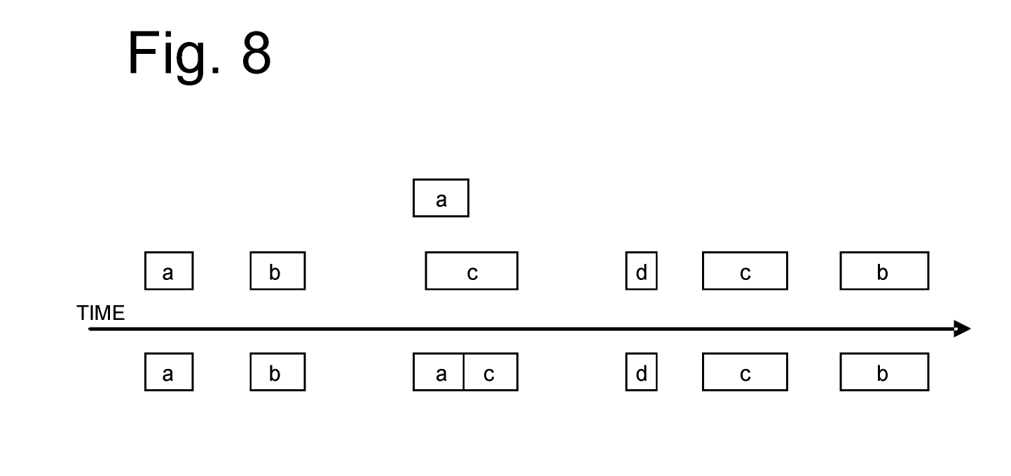

FIG. 8 illustrates the media highlight segments for a media in the timeline. The following highlight segments were identified: two mood segments (a), two zooming segments (b), two OOI segment (c), and one non-OOI segment (d). The lower part of FIG. 4 shows the time segments which contain interesting highlights for the selected media. These are the segments which will be used in the media remix. Depending on the duration of the highlight segment, the segment may be used for the entire duration or only a portion of the segment is used. The user can specify how much of his/her content should be used in the media remix. Depending on this value the media remix can adjust the interval when to include the highlight media. For example, it may be possible that in some cases (depending of segment length) every other view is from the highlight media if that media should appear regularly in the final media remix.

In the previous, an embodiment for personalizing media remix according to user experienced highlights was disclosed. Such a media remix can be further personalized by including such segments to the remix that includes video and/or still images of the user. Therefore, the personalized media remix includes highlights for the user but also recordings of the user experiencing the highlights. In order to carry this out, an embodiment of the present invention proposes locating user segments from other user's media. This can be implemented so that front camera shots are taken by the user's recording device during the media capture. Such image shots that includes the face of the user are used as a reference image. The front camera shots can be associated with sensor data such as compass and/or gyroscope/accelerometer data. The front camera shots may also have a timestamp that relates to the start of the media. Yet further, the camera shots may contain one or more still images.

The content of the reference image is searched from other media files taken by other users. The potential other media files from which the content of the reference is searched can be selected by comparing capture times of the media files. The capture time may be included as metadata in a media file. When a set of potential media files are selected, the content of them is examined in order to find a corresponding content with the content of the reference image. As a result of the examination, such media files, which are captured by one or more other users and which comprises a specified user as content are found. After having found media segments including video of the specified user, these media files (partly or in total) can be included in the personalized media remix.

Turning again to FIG. 6 illustrating a high level block diagram of an embodiment for the recording device. To utilize the further embodiment for personalization, the shots (e.g. still images) by the front camera (640) are taken at certain time intervals and those time instances along with the (optional) still images are stored for later use as a reference image.

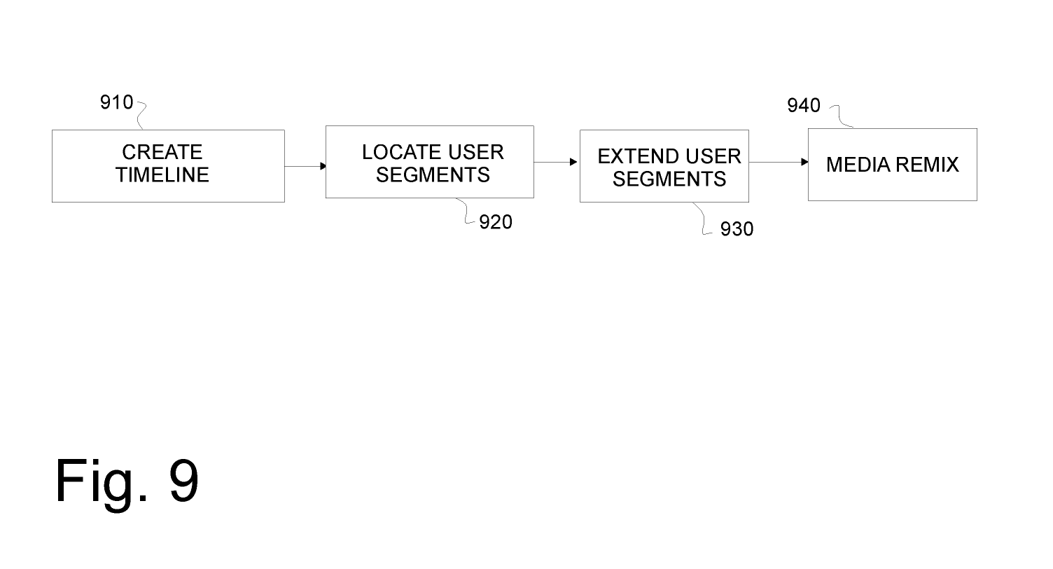

FIG. 9 illustrates a high level block diagram of the embodiment for the server. At first a common timeline is created (910) for the participating media, i.e. the captured media received from plurality of recording devices. Next, media segments that includes a specified user as content are determined (920). These segments can be found by comparing the media from other users to the reference image of the specified user. If the media from other users contain the content of the reference image, such media segments are stored for remixing purposes. Further, the determined segments may be extended (930) to cover also such segments or time instances that most likely contain the specified user based on the previous (920) analysis results. Finally, the identified segments are rendered (940) to the media remix. In some situations, the user may only request as the final media remix, only the identified segments relating to the user. Therefore, the server is also capable of creating a media remix comprising only media material of the specific user.

The front camera shots can be analyzed according to following steps in order to create a reference image/video:
1 Take image shot using front camera or alternatively extract image from front camera video
2 Is face included?
3 Is it user's face?
4 Store face and timestamp
5 Go to step 1 if media capturing still active

For step 3, the user has had to provide a reference image of user's face to the recording device. Otherwise it cannot be determined whether the face is user's.

The front camera analysis makes it sure that the user is at best position in order to be located from other user's media. In an embodiment, also such time instances may be saved, where user's face is not detected. This is because, that may indicate interesting moment for the user in question. In such a case the previous steps 2-4 would be replaced merely with step “store front camera image and timestamp”.

The front camera may store data in the following format:

time_instant, (face_image)

where time_instant is the time instant of the still image with respect to the start of the media capture. The captured face (face_image) may be included for each log entry but there may also be only one face image that is shared by all log entries to save storage space. Alternatively, some entries may share one face image, whereas other entries may share another face. The front camera may operate continuously or image shots are taken at fixed or random intervals. It is appreciated that instead of face image (face_image), also some other content can be stored with time instant, as mentioned above.

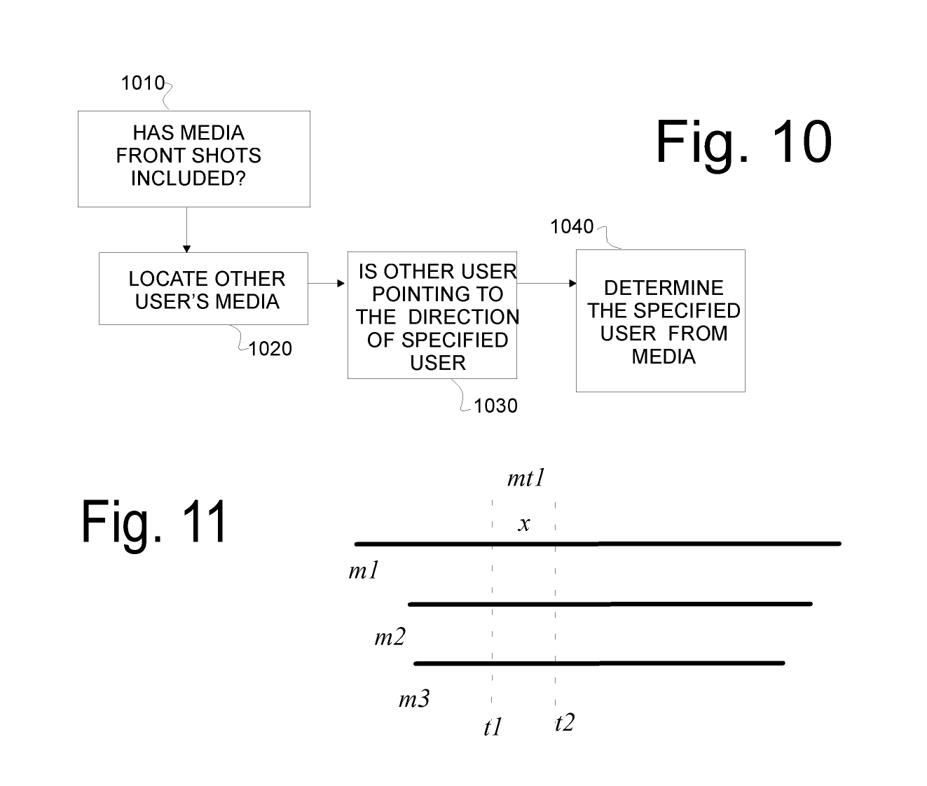

FIG. 10 illustrates a block diagram for locating the specified user segments from other user's media. First, the media from specified user is analyzed to see if data relating to front camera shots is included (1010). For this embodiment, the front camera data is used to define a reference image. If such data is present, the other user's media is then located (1020). Such other user's media can be located by determining the overlapping media with respect to the specified user's media, e.g. by comparing capturing times of the reference image and the other user's media. If there is not any front camera data that can be interpreted as reference image, the determination of user segments is terminated for this media. After having the identified media segments from block 1020, each identified media segment is analyzed to see whether the other user having captured the media segment in question is possibly pointing towards the specified user (1030). This can be done by utilizing sensor data being included in the metadata of the media file. If it is determined that the other user is most likely pointing towards the specified user, the final step (1040) is then to confirm this by analyzing the actual media segment and finding the specified user from the media segment. Steps 1030 and 1040 are repeated for each identified media from step 1020. In addition, steps 1010-1040 may be repeated for each media that belongs to the specified user.

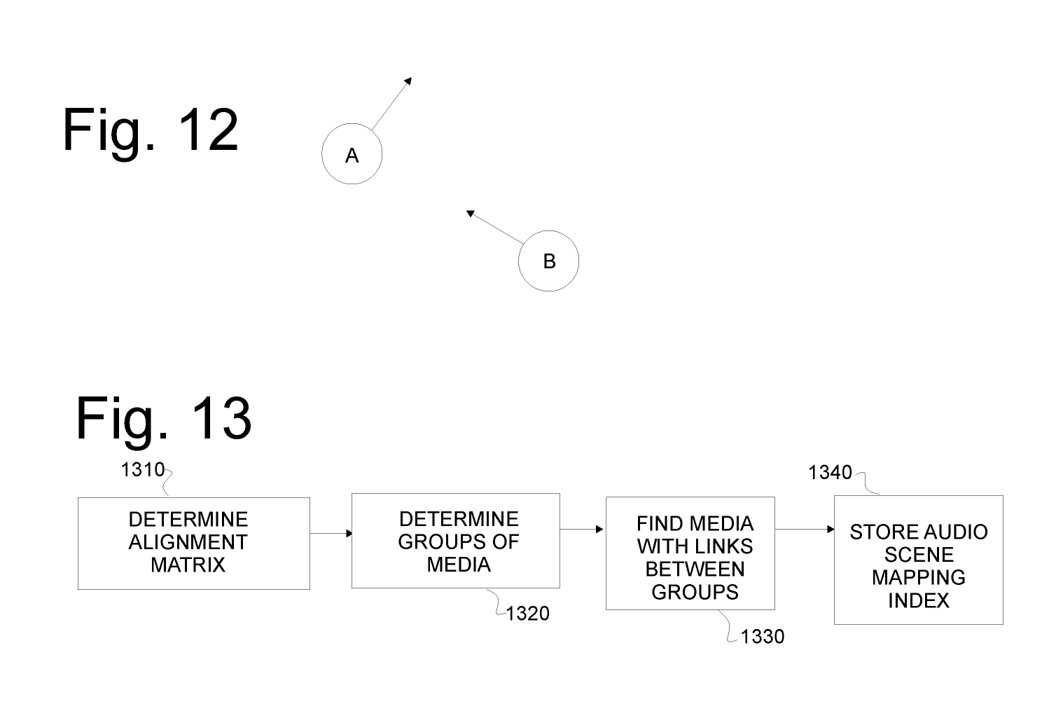

FIG. 11 illustrates an example for FIG. 10. Let m₁ represent one of the media of the specified user. The media has one face related shot at time instant mt₁. Next, overlapping media is determined using the common timeline and in this case the overlapping media with respect to media m₁ at time instant mt₁ are m₂ and m₃. After this, it is determined, whether these two media m₂, m₃ are pointing towards the specified user. For this purpose, the position and sensor data of the media are analyzed by utilizing the metadata of the media files. If the system is able to provide accurate positioning (see FIG. 12), this can be used for determining whether the other user (FIG. 12: B) is pointing towards the specified user (FIG. 12: A). If, on the other hand, the positioning is not accurate enough or if the users are closely located (within few meters), the positioning data may be unreliable due to errors in the actual position. Therefore, other techniques may be used to determine the media which include the specified user in the media view. One of such techniques is to determine the direction of capturing for the specified user media and based on this value, the target direction of capturing can be determined for the other user's media. Let cxₜ be the capturing direction of the specified user media at time instant mt₁. The target direction of capturing can then be determined according to

$$cDiff = \{ \begin{matrix}{cx}_{t} - 180 ° , & {cx}_{t} - 180 ° \geq 0 \\ 360 ° + ( {cx}_{t} - 180 ° ) , & otherwise\end{matrix} \\ cThr = cDiff \pm cDev$$

where cDev is the direction angle deviation, for example ±45°. It can be determined, that the other media points to the specified user if its direction of capturing cyₜ at time instant mt₁ satisfies the following condition:

cThrₘᵢₙ≦cyₜ≦cThrₘₐₓ

Once it has been verified that other user is pointing towards the specified user, the next step is to verify this from the captured media. This can be realized according to following steps:
1 Extract media view
2 Is face included?
3 Is it specified user's face?
4 Direction of capturing verified
5 Go to step 1 if media views still available

To ensure efficient operation, only the media views in the vicinity of the specified time instance can be analyzed (in FIG. 11 between t₁ and t₂). After above steps have been completed, the rendering server will become aware of the media that includes the specified user.

The duration of the media segments including the specified user may be fixed (e.g. ±t seconds around the time instance mt₁) or determined, e.g. by using object tracking in order to determine, e.g. how long the face/head remains in the view if compass angle stays the same in both media. Furthermore, in order to improve detection robustness, all face image shots can be used until a match is found. In addition, the detection may apply different correction techniques to the uploaded face in case the face image is not exactly matching the direction of capturing in the other user's media.

It is also possible that the face detection fails to produce positive output (i.e. presence of specified user is not verified). In that case the verification may occur only at the sensor data level and this verification mode can be separately signaled to the rendering server. If the direction of capturing is valid according to above equations, even though the face is not found, the segment can still be marked as “potential face found”. There can be couple of levels of potential verifications: 1) the specified user was found from the media but from different position, i.e. at some time instance the verification was successful, but at another time instant of the same media, positive output could not be produced; 2) the specified user was not found from the media at all, but the equations are valid making the chance of the specified user to be present in such media very high. The rendering may then occur such that first the segments with positive output are selected, and if it is required that certain amount of segments comprising the specified user should be present in the media remix, level 1 can be processed next and followed by level 2.

In the previous, a method for locating a specified user from a media being captured by other user's recording devices. In such method, media from all other users may be examined to locate the specified user, or only such media is examined that is captured by such other users that are temporally close enough to the specified user.

In addition to these alternatives, yet another possibility to select the media for examination is disclosed next.

In this embodiment, only such media is examined for locating a specified user, which is captured by recording devices belonging to same cluster with the specified user. The cluster can be determined according to a grouping factor such as a location being based on e.g. GPS (Global Positioning System), GLONASS (Global Navigation Satellite System), Galileo, Beidou, Cellular Identification (Cell-ID) or A-GPS (Assisted Global Positioning System). In the following, the cluster is created according to a grouping factor being a common audio scene.

FIG. 13 illustrates a high level block diagram of an embodiment. Let xᵢ^{t} represent media signals for overlapping time segment t with 0≦i<N, where N is the number of signals in the segment. The steps of FIG. 13 is applied for each time segment. First, an alignment matrix is determined for the multi-user media (1310), i.e. the media being received from plurality of recording devices. Next, the alignment matrix is mapped to groups of media (1320), in order to find out which media belong to same group. The group structures are analyzed and media which acts as links with other media are determined (1330).

The purpose of the alignment matrix is to describe the relation of a signal with respect to the other signals. The audio scene status is a metric that indicates whether the audio scenes of two media are similar.

The steps 1310-1330 of FIG. 13 are now described in more detail. The matrix entries for the alignment matrix may be determined using time alignment methods known in the art such that matrix entry ‘1’ indicates that the signals share the audio scene that can be aligned, and matrix entry ‘0’ indicates that the signals do not share exactly the same audio scene, that is, the signals may still be from the same audio scene but due to various issues such as different capturing positions and surrounding ambience level at the actual capturing position, the signals do not align. It is realized that the alignment matrix summarizes the audio scene status of a media with respect to the other media.

In the following example, the main steps according to an embodiment are described. a, b, c, d and e represents the signals that are part of a time segment.

The alignment matrix after time aligning each signal pair in the group of signals may look as follows:

$$\begin{matrix} & a & b & c & d & e \\ a & 1 & 1 & 0 & 0 & 0 \\ b & 1 & 1 & 1 & 0 & 0 \\ c & 0 & 1 & 1 & 1 & 1 \\ d & 0 & 0 & 1 & 1 & 1 \\ e & 0 & 0 & 1 & 1 & 1\end{matrix}$$

The signal groups (i.e. groups having aligned signals) are then
(a, b)
(a, b, c)
(b, c, d, e)
(c, d, e)
(c, d, e)

As a next step, it needs to be determined which groups can be the basis for the groups by analyzing whether the signal group is a subset of another group. After applying this analysis, the preliminary basis group structure is:
(a, b): 2 counts
(a, b, c): 1 count
(b, c, d, e): 1 count
(c, d, e): 2 counts

The groups which can be the basis for the groups need to have at least two count instants, whereby the final media grouping is
(a, b), (c, d, e)

The next step is to locate the signal that contains (or signals that contain) a link to other signal groups. The final media groups are compared against the preliminary basis groups that contain only single count instance. Thus the comparisons are

$$\{ \begin{matrix}( a , b ) vs ( a , b , c ) \\ ( a , b ) vs ( b , c , d , e )\end{matrix} and \{ \begin{matrix}( c , d , e ) vs ( a , b , c ) \\ ( c , d , e ) vs ( b , c , d , e )\end{matrix}$$

The final media group needs to be a subset of the signal group to which it is compared against and after eliminating the non-subset groups, the final comparison is as follows:
(a,b) vs (a,b,c), (c,d,e) vs (b,c,d,e)

which means that signal that is linking with first group is signal c, and the signal that is linking with the second group is signal b.

The mapping data that is stored for this time segment is therefore
Media groups: (a, b) and (c, d, e)
Linking media: c and b

As a final step of FIG. 13, this mapping data is stored (1340) as audio scene mapping index for rendering purposes.

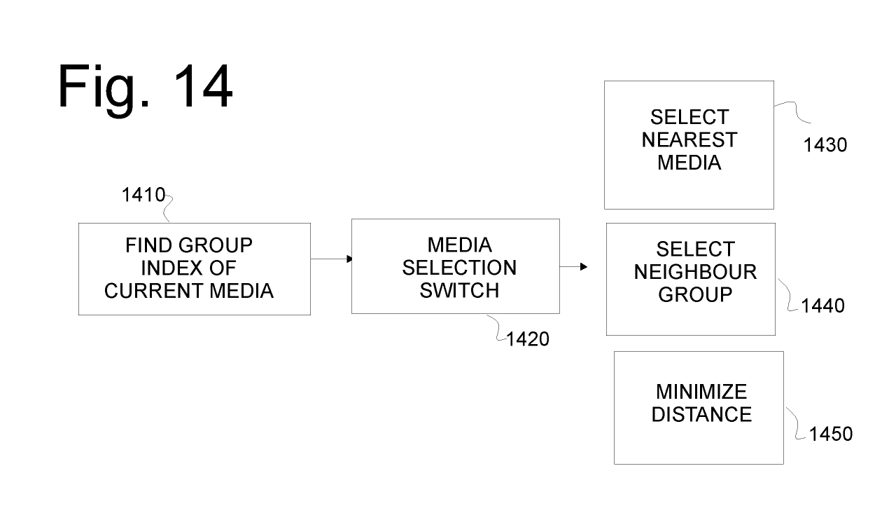

Once the mapping data is available for each time segment, the media switching may take place. FIG. 14 illustrates a high level block diagram of an embodiment for applying the previous analysis data to the multi-user media remix.

The first step in the media switching is to locate/determine (1410) the grouping data that contains the currently selected/viewed media. Let the grouping data be yⱼ with 0≦j<M where M is the number of signals in the segment. This grouping data is then used in combination with the media selection switch to determine the next media view (1420) to be examined in order to find an image of the specified user. This can be carried out by locating the media group within the grouping data and then determine the next media. To select the media for examination, the selection may follow predefined rules. For example, at certain times (time intervals) the next media view to be selected for examination can be near to the current view (1430). In such case, the media should be selected to be one of the media from the same media group (e.g. current media is a and next media is b). At certain times (time intervals), however, the next media view to be selected for examination can be from neighbouring media group (1440). In this case, the next media may be selected in such a manner that it is one of the media from some other media group that is selected using the media links (e.g. from media a to media d where c is the linking media in between groups). At certain times (time intervals) the next media for examination can be such that it has minimum distance to the current media view (1450). It is appreciated that other switching logics may be generated by using the audio scene mapping data.

It is also appreciated that a group contains multiple linking media to different groups. The audio scene mapping data effectively clusters the signals that are present in the scene. Signals that appear to be in the vicinity of each other during capturing may get assigned to different groups. Thus, the clusters represents a virtual grouping of the media signals present in the scene and when mapping data is indexed in controlled manner, the end user experience may be better than randomly selecting the media views.

The overall end-to-end framework may be traditional client-server architecture where the server resides at the network or ad-hoc type of architecture where one the capturing devices may act as a server. The previous functions may be shared between the client device and the server device so that the client at least performs the media capturing and detecting the sensor data that can be utilized for giving information of the captured media. In addition, the client device may utilize the front camera to give information on user's moods and/or to provide means to detect user from other user's media. The server device can then perform the rendering of the captured media from plurality of recording devices. For the rendering, the server may user the personalization data received from one or more of the recording devices, so that the media remix will contain user experienced highlights. In addition, the server may use such media that has been captured of the specific user. As a result, the media remix will contain also recording of the user e.g. at the time the user is experiencing the highlights. However, in order to carry this out, the server needs to go through the media views received from other user's. To help this process, one of the present embodiments propose to create clusters by means of e.g. audio to see which users potentially could have media views of the specific user.

There is also few possibilities to create the media remix. For example, user A may request such a media remix that also comprises only such highlights that are specific for user A (i.e. provided by the user A). As an another example, user A may request such a media remix that also comprises highlights of selected users B-D. Yet as an another example, user A may request such media remix that also comprises all the highlights that were obtained together with the media view. These alternatives can be completed with media views being captured of the user A. In another embodiment the user A may also request such media remix that has been created only of such media content that relates to the highlights of the user A. In such a case, the media remix is a personal summary of a complete event.

The various embodiments may provide advantages. For example, personalized media remix can be thought are most valuable and important aspect when rendering multiuser content. The personalization combines different media view, with personalized highlights. In addition, an embodiment of the solution provides computationally efficient personalization that is based on media groups being created according to a time scene. By means of the present embodiments, the user is able to receive personalized media remix that is based on a media being received from multiple recording devices.

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1-49. (canceled)

50. A method, comprising:
receiving media content from at least one recording device, wherein at least one media content received from said at least one recording device is complemented with personating data;
creating remixed media content of the media content being received with said at least one personating data.

51. The method according to claim 50, wherein the personating data is data on user activities during media capture.

52. The method according to claim 50, wherein the personating data is data on activities of the recording device during media capture.

53. The method according to claim 50, wherein the personating data includes a face image of the user of the recording device.

54. The method according to claim 53, further comprising
analyzing a mood of the user by means of the received face image.

55. A method, comprising:
capturing media content by a recording device;
monitoring the capture of the media content by
logging personating data to the recording device;
transmitting at least part of the captured media content to a server, which at least part of the captured media is complemented with the personating data.

56. The method according to claim 55, wherein the personating data is data on user activities during media capture.

57. The method according to claim 55, wherein the personating data is data on activities of the recording device during media capture.

58. The method according to claim 55, wherein the personating data includes a face image of the user of the recording device.

59. An apparatus comprising at least one processor, memory including computer program code, the memory and the computer program code configured to, with the at least one processor, cause the apparatus to perform at least the following:
receive media content from at least one recording device, wherein at least one media content received from said at least one recording device is complemented with personating data;
create remixed media content of the media content being received from with said at least one personating data.

60. The apparatus according to claim 59, wherein the personating data is data on user activities during media capture.

61. The apparatus according to claim 59, wherein the personating data is data on activities of the recording device during media capture.

62. The apparatus according to claim 59, wherein the personating data includes a face image of the user of the recording device.

63. The apparatus according to claim 62, further comprising computer program code configured to, with the processor, cause the apparatus to perform at least the following:
analyze a mood of the user by means of the received face image.

64. The apparatus according to claim 62, wherein the received media content is at least partly video content, whereby the apparatus further comprises computer program code configured to, with the processor, cause the apparatus to perform at least the following:
examine the video content received from multiple recording devices to find such content that comprises data corresponding to the face image.

65. A recording apparatus comprising at least one processor, memory including computer program code, the memory and the computer program code configured to, with the at least one processor, cause the apparatus to perform at least the following:
capture media content;
monitor the capture of the media content by
logging personating data to the recording apparatus;
transmit at least part of the captured media content to a server, which at least part of the captured media is complemented with the personating data.

66. The recording apparatus according to claim 65, wherein the personating data is data on user activities during media capture.

67. The recording apparatus according to claim 65, wherein the personating data is data on activities of the recording device during media capture.

68. The recording apparatus according to claim 65, wherein the personating data includes a face image of the user of the recording device.

69. A computer program product embodied on a non-transitory computer readable medium, comprising computer program code configured to, when executed on at least one processor, cause an apparatus or a system to:
receive media content from at least one recording device, wherein at least one media content received from said at least one recording device is complemented with personating data;
create remixed media content of the media content being received with said at least one personating data.
